(19) United States
(12) Patent Application Publication
(10) Pub. No.: US 2003/0228819 A1
(43) Pub. Date: Dec. 11, 2003

(54) Material adapted to dissipate and reduce vibrations and method of making same

(75) Inventors: Robert A. Vito, Berwyn, PA (US); Thomas Falone, Michleton, NJ (US); Carmen A. DiMario, West Chester, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Innercore Grip Company, Berwyn, PA

(21) Appl. No.: 10/360,353

(22) Filed: Feb. 7, 2003

Related U.S. Application Data
(63) Continuation-in-part of application No. 10/173,063, filed on Jun. 17, 2002.
(63) Continuation-in-part of application No. 10/165,748, filed on Jun. 7, 2002.

(51) Int. Cl. B32B 5/16; B32B 15/02; B32B 15/14; B32B 15/16; B32B 25/02; B32B 25/10; B32B 27/02

(52) U.S. Cl. 442/169; 442/164; 442/250; 442/260; 442/293; 442/294; 428/402

(57) ABSTRACT

A material adapted to regulate vibration by distributing and partially dissipating vibration exerted thereon. The material includes a first elastomer layer. A support structure is preferably formed by a second elastomer layer. The support structure being located and configured to support the first elastomer layer.

### CROSS REFERENCE TO RELATED APPLICATION

This application is a continuation in part of and claims priority from the following U.S. patent applications: U.S. patent application Ser. No. 10/173,063, filed Jun. 17, 2002, entitled “Material Adapted to Dissipate and Reduce Vibrations and Method of Making Same” which is hereby incorporated by reference herein as if fully set forth in its entirety; U.S. patent application Ser. No. 10/165,748, entitled “Multi-Layer Material Adapted to Dissipate and Reduce Vibrations,” filed on Jun. 7, 2002, which is hereby incorporated by reference herein as if fully set forth in its entirety; and U.S. Patent Application entitled “Material Adapted to Dissipate and Reduce Vibrations and Method of Making Same,” filed on Jan. 17, 2003, invented by Robert A. Vito et al., serial number not yet known, which is hereby incorporated by reference herein as if fully set forth in its entirety.

### BACKGROUND

The present invention is directed to a material adapted to reduce vibration and, more specifically, to a method of making a material adapted to dissipate and evenly distribute vibrations acting on the material.

Handles of sporting equipment, bicycles, hand tools, etc. are often made of wood, metal or polymer that transmit vibrations that can make the items uncomfortable for prolonged gripping. Sporting equipment, such as bats, balls, shoe insoles and sidewalls, also transmit vibrations during the impact that commonly occurs during athletic contests. These vibrations can be problematic in that they can potentially distract the player's attention, adversely effect performance, and/or injure a portion of a player's body.

Rigid polymer materials are typically used to provide grips for tools and sports equipment. The use of rigid polymers allows users to maintain control of the equipment but is not very effective at reducing vibrations. While it is known that softer materials provide better vibration regulation characteristics, such materials do not have the necessary rigidity for incorporation into sporting equipment, hand tools, shoes or the like. This lack of rigidity allows unintended movement of the equipment encased by the soft material relative to a user's hand or body.

Prolonged or repetitive contact with excessive vibrations can injure a person. The desire to avoid such injury can result in reduced athletic performance and decreased efficiency when working with tools.

Clearly what is needed is a method of making a material adapted to regulate vibration that provides the necessary rigidity for effective vibration distribution and for a user to maintain the necessary control of the implement; and that can dampen and reduce vibrational energy.

### SUMMARY

One embodiment of the present invention is directed to a material adapted to regulate vibration by distributing and partially dissipating vibration exerted thereon. The material includes a first elastomer layer. A support structure is penetrated by and embedded on and/or within the elastomer layer. The support structure is semi-rigid and supports the elastomer layer. The support structure has a first plurality of particles therein.

In another aspect, the present invention is directed to a material adapted to regulate vibration by distributing and partially dissipating vibration exerted thereon. The material includes a first elastomer layer. A support structure is formed by a second elastomer layer. The support structure is located and configured to support the first elastomer layer.

In another aspect, the present invention is directed to a material adapted to regulate vibration by distributing and partially dissipating vibration exerted thereon. The material includes a first elastomer layer. A support structure is located and configured to support the elastomer layer. The support structure has a first plurality of gel particles therein.

### BRIEF DESCRIPTION OF THE DRAWINGS

The foregoing summary, as well as the following detailed description of the preferred embodiments of the present invention will be better understood when read in conjunction with the appended drawings. For the purpose of illustrating the invention, there are shown in the drawings embodiments which are presently preferred. It is understood, however, that the invention is not limited to the precise arrangements and instrumentality shown. In the drawings:

FIG. 1 is a cross-sectional view of a preferred embodiment of the material of the present invention illustrating a single layer vibration dissipating material with a support structure embedded therein, the material extends along a longitudinal portion of an implement and covers a proximal end thereof;

FIG. 2 is a cross-sectional view of the material of FIG. 1 separate from any implement, padding, equipment or the like;

FIG. 2A is a cross-sectional view of a second preferred embodiment of the material of the present invention with the support structure embedded thereon and the vibration dissipating material penetrating the support structure;

FIG. 2B is cross-sectional view of a third preferred embodiment of the material of the present invention with the support structure embedded within the vibration dissipating material and the vibration dissipating material penetrating the support structure, the support structure is positioned off center within the vibration dissipating material;

FIG. 3 is a cross-sectional view of a first preferred embodiment of the support structure as taken along the lines 3-3 of FIG. 2, the support structure is formed of polymer and/or elastomer and/or fibers, either of which may contain fibers, passageways extend through the support structure allowing the vibration dissipating material to penetrate the support structure;

FIG. 4 is cross-sectional view of a second preferred embodiment of the support structure as viewed in a manner similar to that of FIG. 3 illustrating a support structure formed by woven fibers, passageways through the woven fibers allow the support structure to be penetrated by the vibration dissipating material;

FIG. 5 is cross-sectional view of a third preferred support structure as viewed in a manner similar to that of FIG. 3; the support structure is formed by pluralities of fibers and particles; passageways past the fibers allow the vibration dissipating material to preferably penetrate the support structure;

FIG. 6 is a side elevational view of the support structure of FIG. 3;

FIG. 7 is perspective view of the material of FIG. 1 configured to form a grip for a bat; and

FIG. 8 is perspective view of the material of FIG. 1 configured to form a grip for a racquet.

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made. The words “inwardly” and “outwardly” refer to directions toward and away from, respectively, the geometric center of the material and designated parts thereof. The term “implement,” as used in the specification and in the claims, means “any one of a baseball bat, racquet, hockey stick, softball bat, sporting equipment, firearm, or the like.” The term “particles,” as used in the claims and in the corresponding portions of the specification, means “small bits or pieces of mass each defining a volume but generally being of insufficient, length to interweave together.” Additionally, the words “a” and “one” are defined as including one or more of the referenced item unless specifically stated otherwise. The above terminology includes the words above specifically mentioned, derivatives thereof, and words of similar import.

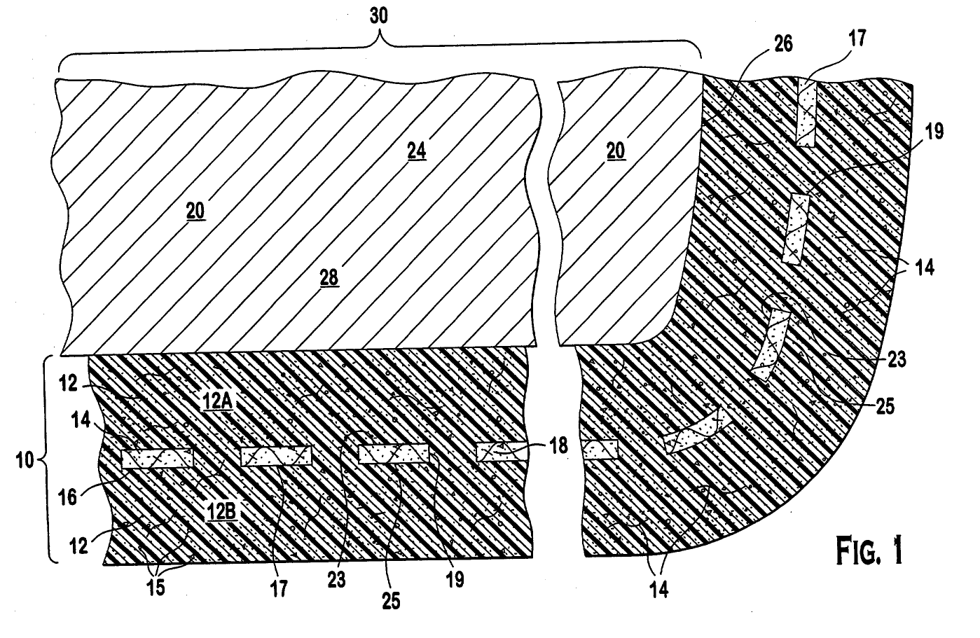

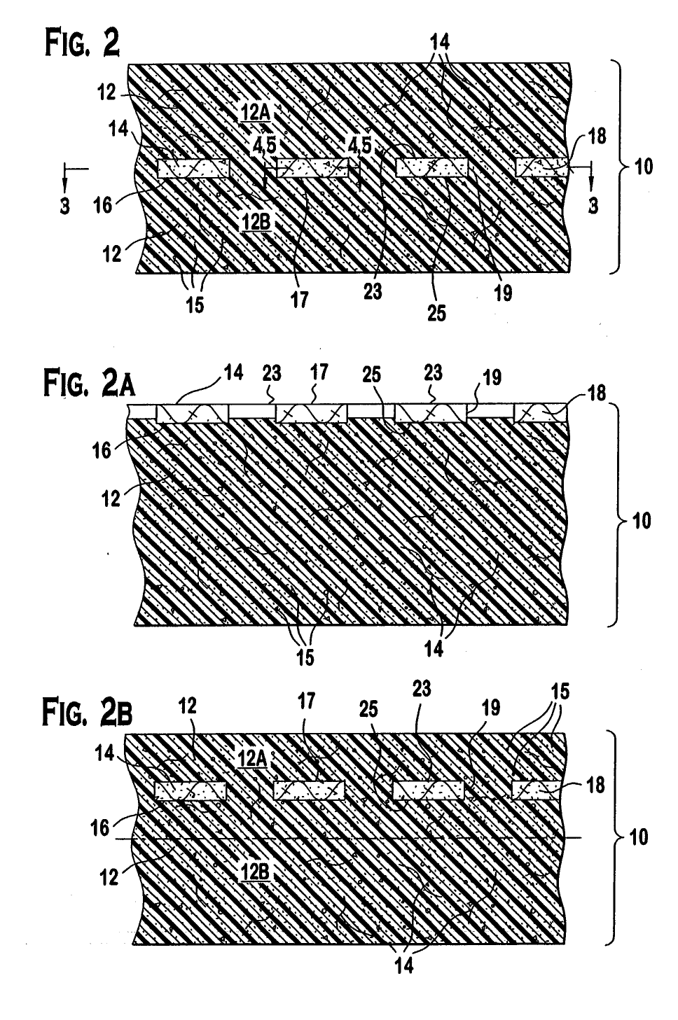

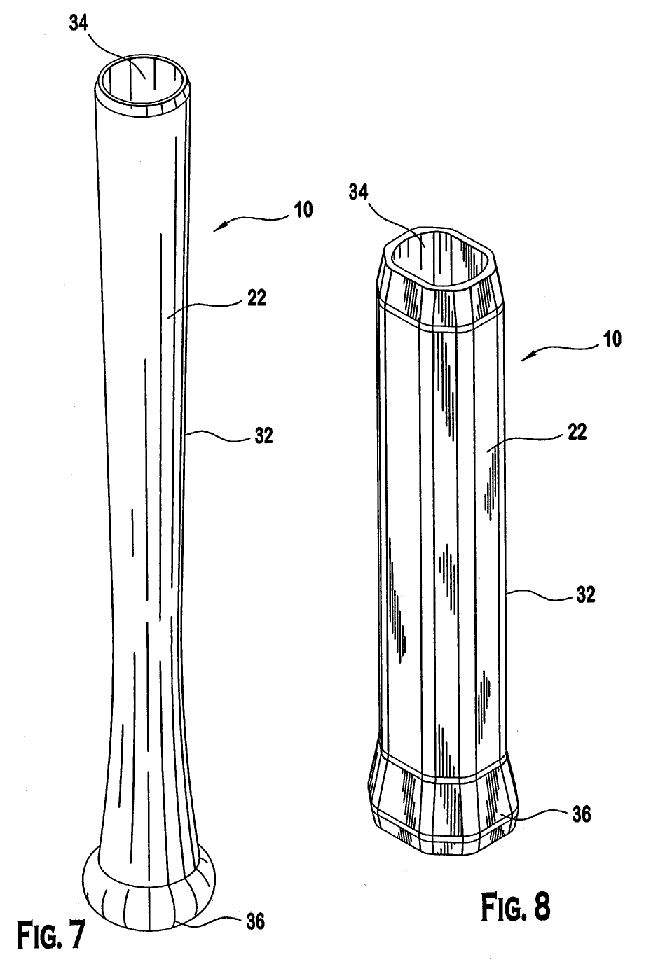

Referring to FIGS. 1-8, wherein like numerals indicate like elements throughout, there are shown preferred embodiments of a material, generally designated 10, that is adapted to regulate vibration. Briefly stated, the material 10 preferably includes a vibration dissipating material 12 (preferably an elastomer layer). The vibration dissipating material 12 penetrates a support structure 17 to embed the support structure 17 thereon (as shown in FIG. 2A) and/or therein (as shown in FIG. 2B). The support structure 17 is preferably semi-rigid (but can be rigid without departing from the scope of the present invention) and supports the vibration dissipating material 12. The support structure can be formed by a second elastomer layer of same or differing rigidity.

The material 10 of the present invention was the result of extensive research and was throughly tested by Villanova University's Department of Mechanical Engineering by a professor having a Ph.D. in vibratory physics. Testing of the material 10 determined that the material 10 can reduce the magnitude of sensible vibration by eighty (80%) percent. The material 10 has verified, superior vibration dissipation properties due to the embedded support structure 17 that is located on and/or in the elastomer 12. In addition to evenly distributing vibration, the support structure 17 contributes to the absorption of vibration and supports the vibration dissipating material 12 to prevent the layer of vibration dissipating material 12 from twisting or otherwise becoming unsuitable for use as a grip or padding.

While it is preferred that the vibration dissipating material layer 12 be formed by elastomer, those of ordinary skill in the art will appreciate from this disclosure that the vibration dissipating material 12 can be formed by any suitable polymer without departing from the scope of the present invention. For clarity only, the vibration dissipating material 12 will be often described herein as being an elastomer without any mention of the material possibly being a polymer. However, it should understood that even when the layer 12 is only described as being an elastomer, that the present invention also includes the material 12 being a any suitable polymer.

The material 10 of the present invention can be incorporated into athletic gear, grips for sports equipment, grips for tools, and protective athletic gear. More specifically, the material 10 can be used: to form grips for a tennis racquet, hockey sticks, golf clubs, baseball bats or the like; to form protective athletic gear for mitts, headbands, mouth guards, face protection devices, helmets, gloves, pads, exercise pads, elevator pads, padding that is stood on, padding that is wrapped around objects to protect people from injury when colliding with such objects, hip pads, shoulder pads, chest protectors, or the like; to form seats or handle bar covers for bicycles, motorcycles, or the like; to form boots for skiing, roller blading or the like; to form footwear, such as shoe soles and inserts; to form grips for firearms, hand guns, rifles, shotguns, or the like; and to form grips for tools such as hammers, drills, circular saws, chisels or the like.

The elastomer layer 12 acts as a shock absorber by converting mechanical vibrational energy into heat energy. The embedded support structure 17 redirects vibrational energy and provides increased stiffness to the material 10 to facilitate a user's ability to control an implement 20 encased, or partially encased, by the material 10. The elastomer layer 12, 12A, or 12B may include a plurality of fibers 14 (further described below) or a plurality of particles 15 (further described below). The incorporation of the support structure 17 on and/or within the material 10 allows the material 10 to be formed by a single elastomer layer without the material 10 being unsuitable for at least some of the above-mentioned uses. The support structure 17 may also include a plurality of fibers 14 or a plurality of particles 15. However, those of ordinary skill in the art will appreciate from this disclosure that additional layers of material can be added to any of the embodiments of the present invention disclosed below without departing from the scope of the invention.

In the situation where the support structure 17 is formed by a second elastomer layer, the two elastomer layers can be secured together via an adhesive layer, discreet adhesive locations, or using any other suitable method to secure the layers together. Regardless of the material used to form the support structure 17, the support structure is preferably located and configured to support the first elastomer layer (see FIGS. 1-2B).

It is preferred that the material 10 have a single contiguous elastomer body 12. Referring to FIG. 1, the support structure has first and second major surfaces 23,25. In one embodiment, the elastomer 12 extends through the support structure 17 so that the portion of the elastomer 12A contacting the first major support structure surface 23 (i.e., the top of the support structure 17) and the portion of the elastomer 12B contacting the second major support structure surface 25 (i.e., the bottom of the support structure) form the single contiguous elastomer body 12. Elastomer material provides vibration damping by dissipating vibrational energy. Suitable elastomer materials include, but are not limited, urethane rubbers, silicone rubbers, nitrile rubbers, butyl rubbers, acrylic rubbers, natural rubbers, styrene-butadiene rubbers, and the like. In general, any suitable elastomer or polymer material can be used to form the vibration dissipating layer 12.

The softness of elastomer materials can be quantified using Shore A durometer ratings. Generally speaking, the lower the durometer rating, the softer the material and the more effective a material layer is at absorbing and dissipating vibration because less force is channeled through the material. When a soft material is squeezed, an individual's fingers are imbedded in the material which increases the surface area of contact between the user's hand and creates irregularities in the outer material surface to allow a user to firmly grasp any implement 20 covered, or partially covered, by the material. However, the softer the material, the less control a user has when manipulating an implement 20 covered by the material. If the elastomer layer is too soft (i.e., if the elastomer layer has too low of a Shore A Durometer rating), then the implement 20 may rotate unintentionally relative to a user's hand or foot. The material 10 of the present invention is preferably designed a Shore A durometer rating that provides an optimum balance between allowing a user to precisely manipulate and control the implement 20 and effectively damping vibration during use of the implement 20 depending on the activity engaged in.

It is preferable, but not necessary, that the elastomer used with the material 10 have a Shore A durometer of between approximately ten (10) and approximately eighty (80). It is more preferred that the elastomer 12 have a Shore A durometer of between approximately fifteen (15) and approximately forty-five (45).

The elastomer 12 is preferably used to absorb vibrational energy and to convert vibrational energy into heat energy. The elastomer 12 also provides a compliant and comfortable grip for a user to grasp (or provides a surface for a portion of a user's body, such as the under sole of a user's foot when the material 10 is formed as a shoe insert).

In one embodiment, the material 10 preferably has a Shore A durometer of approximately fifteen (15). In another embodiment, the material 10 preferably has a Shore A Shore Durometer of approximately forty two (42). In yet another embodiment, the material 10 preferably has a Shore A Durometer of approximately thirty-two (32). Of course, those of ordinary skill in the art will appreciate that the Shore A Durometer of the material 10 can varied without departing from the scope of the present invention.

Referring to FIGS. 3-5, the support structure 17 can include any one (or combination of) of a polymer, an elastomer, particles, a plurality of fibers, a plurality of woven fibers, a cloth, and a plurality of cloth layers. If the support structure 17 and the layer 12 are both polymers or both elastomers, then they can be the same or different from each other without departing from the scope of the present invention. If vibration dissipating material is 12 if formed of the same material as the support structure 17, then the support structure 17 can be made more rigid than the main layer 12 by embedding fibers 14 therein. It is preferable that the support structure 17 is generally more rigid than the vibration dissipating material 12.

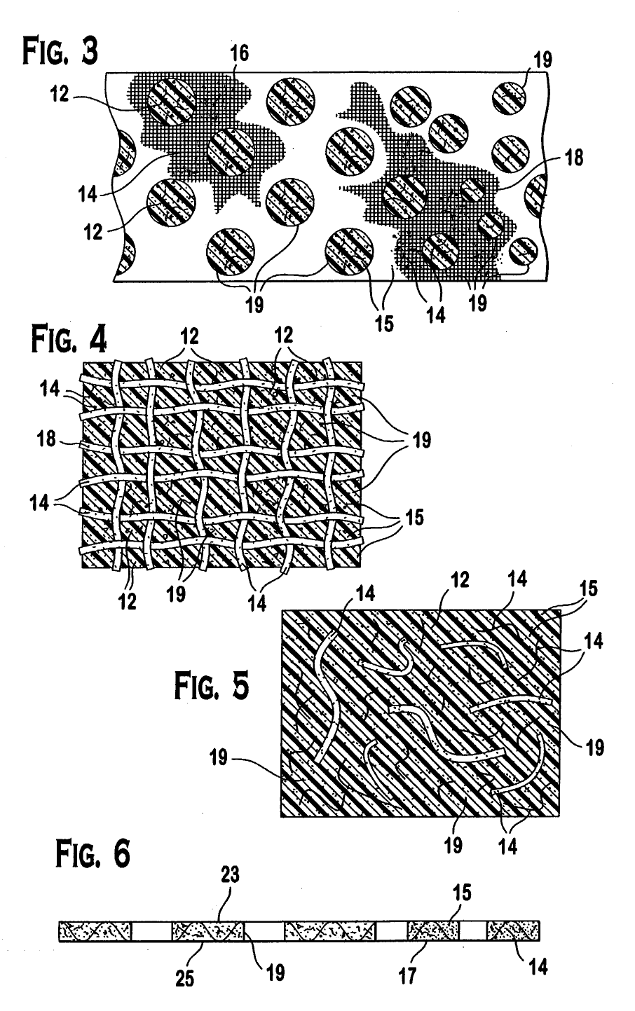

Referring specifically to FIG. 3, the support structure 17 may be formed of an elastomer that may but does not necessarily, also have fibers 14 embedded therein (examplary woven fibers are shown throughout portions of FIG. 3). Referring to FIG. 4, the support structure 17 may be formed by a plurality of woven fibers 18. Referring to FIG. 5, the support structure 17 may be formed by a plurality of fibers 14. Regardless of the material forming the support structure 17, it is preferable that passageways 19 extend into the support structure 17 to allow the elastomer 12 to penetrate and embed the support structure 17. The term “embed,” as used in the claim and in the corresponding portions of the specification, means “contact sufficiently to secure thereon and/or therein.” Accordingly, the support structure 17 shown in FIG. 2 A is embedded by the elastomer 12 even though the elastomer 12 does not fully enclose the support structure 17. Additionally, as shown in FIG. 2 B, the support structure 17 can be located at any level or height within the elastomer 12 without departing from the scope of the present invention. While the passageways 19 are shown as extending completely through the support structure 17, the invention includes passageways 19 that extend partially through the support structure 17.

Referring again to FIG. 2A, in one embodiment, it is preferred that the support structure 17 be embedded on the elastomer 12, with the elastomer penetrating the support structure 17. The support structure 17 being generally along a major material surface 38 (i.e., the support structure 17 is generally along the top of the material).

The fibers 14 are preferably, but not necessarily, formed of aramid fibers. However, the fibers can be formed from any one or combination of the following: bamboo, glass, metal, elastomer, polymer, ceramics, corn husks, and/or any other renewable resource. By using fibers from renewable resources, production costs can be reduced and the environmental friendliness of the present invention can be increased. Referring to FIG. 4, the fibers 14 can be woven to form a cloth 16 that is disposed on and/or within the elastomer 12. Multiple cloth layers 16 can be epoxied or otherwise secured together and incorporated into the support structure 17. The cloth layer 16 can be formed of woven aramid fibers or other types of fiber. The aramid fibers 14 block and redirect vibrational energy that passes through the elastomer 12 to facilitate the dissipation of vibrations. The aramid fibers 18 redirect vibrational energy along the length of the fibers 18. Thus, when the plurality of aramid fibers 18 are woven to form the cloth 16, vibrational energy emanating from the implement 20 that is not absorbed or dissipated by the elastomer layer 12 is redistributed evenly along the material 10 by the cloth 16 and preferably also further dissipated by the cloth 16.

It is preferable that the aramid fibers 18 are formed of a suitable polyamide fiber of high tensile strength with a high resistence to elongation. However, those of ordinary skill in the art will appreciate from this disclosure that any aramid fiber suitable to channel vibration can be used to form the support structure 17 without departing from scope of the present invention. Additionally, those of ordinary skill in the art will appreciate from this disclosure that loose aramid fibers or chopped aramid fibers can be used to form the support structure 17 without departing from the scope of the present invention. The aramid fibers may also be formed of fiberglass or the like.

When the aramid fibers 18 are woven to form the cloth 16, it is preferable that the cloth 16 include at least some floating aramid fibers 18. That is, it is preferable that at least some of the plurality of aramid fibers 18 are able to move relative to the remaining aramid fibers 18 of the cloth 16. This movement of some of the aramid fibers 18 relative to the remaining fibers of the cloth converts vibrational energy to heat energy.

Particles 15 can be located in either an elastomer layer 12, 12A, and/or 12B and/or in the support structure 15. The particles 15 increase the vibration absorption of the material of the present invention. The particles 15 can be formed of pieces of glass, polymer, elastomer, chopped aramid, ceramic, chopped fibers, sand, gel, foam, metal, mineral, glass beads, or the like. Gel particles 15 provide excellent vibration dampening due their low durometer rating. One exemplary gel that is suitable for use the present invention is silicone gel. However, any suitable gel can be used without departing from the present invention.

The material 10 may be configured and adapted to form an insert for shoe. When the material 10 is configured to form a shoe insert, the material 10 is preferably adapted to extend along an inner surface of the shoe from a location proximate to a heel of the shoe to the toe of the shoe. In addition to forming a shoe insert, the material 10 can be located along the sides and top of the shoe to protect the wearer's foot from lateral and vertical impacts.

The material 10 may be configured and adapted to form a grip 22 for an implement such as a bat, having a handle 24 and a proximal end 26 (i.e., the end near to where the bat is normally gripped). The material 10 is preferably adapted to enclose a portion of the handle 24 and to enclose the proximal end 26 of the bat or implement 20. As best shown in FIGS. 7 and 8, it is preferable that the grip 22 be formed as a single body that completely encloses the proximal end of the implement 20. The material 10 may be also be configured and adapted to form a grip 22 for a tennis racket or similar implement 20 having a handle 24 and a proximal end 26.

While the grip 22 will be described below in connection with a baseball or softball bat, those of ordinary skill in the art will appreciate that the grip 22 can be used with any of the equipment, tools, or devices mentioned above without departing from the scope of the present invention.

When the grip 22 is used with a baseball or softball bat, the grip 22 preferably covers approximately seventeen (17) inches of the handle of the bat as well as covers the knob (i.e., the proximal end 26 of the implement 20) of the bat. The configuration of the grip 22 to extend over a significant portion of the bat length contributes to increased vibrational damping. It is preferred, but not necessary, that the grip 22 be formed as a single, contiguous, one-piece member.

Referring to FIG. 1, the baseball bat (or implement 20) has a handle 24 including a handle body 28 having a longitudinal portion 30 and a proximal end 26. The material 10 preferably encases at least some of the longitudinal portion 30 and the proximal end 26 of the handle 24. The grip material 10 can incorporate any of the above-described support structures 17. The aramid fiber layer 14 is preferably formed of woven aramid fibers 18.

As best shown in FIGS. 7 and 8, the preferred grip 22 is adapted for use with an implement 20 having a handle and a proximal handle end. The grip 22 includes a tubular shell 32 having a distal open end 34 adapted to surround a portion of the handle and a closed proximal end 36 adapted to enclose the proximal end of the handle. It is preferable not necessary, that the material completely enclose the proximal end 26 of the handle. The tubular shell 32 is preferably formed of the material 10 which dissipates vibration.

Multiple methods can be used to produce the composite or multi-layer material 10 of the present invention. Briefly speaking, one method is to extrude the material 10 by pulling a support structure 17 from a supply roll while placing the elastomer layer on both sides of the support structure 17. It is preferred, but not necessary, that the particles 15 in either of the support structure 17 or the elastomer layer are already located in their respective material on the appropriate supply roll. A second method of producing the material 10 of the present invention is to weave a fiber onto the implement 20 and then to mold the elastomer 12 thereover. Alternatively, a support structure can be pressure fit to an elastomer to form the material 10. Those of ordinary skill in the art will appreciate from this disclosure that any other known manufacturing methods can be used to form the material 10 without departing from the scope of the present invention. Any of the below described methods can be used to form a material 10 or grip 22 having any of the above specified Shore A Durometers and incorporating any of the above-described support structures 17.

More specifically, one preferred method of making the material 10 includes: providing an uncured elastomer 12. A cloth layer is positioned on and/or within the uncured elastomer 12. The cloth layer is formed by a plurality of woven aramid fibers 14. The uncured elastomer 12 penetrates the cloth layer 16 to embed to the cloth 16. The uncured elastomer 12 is at least partially cured to form the material 10. The cloth layer 16 supports the cured elastomer 12 and facilitates the distribution and dissipation of vibration by the material 10.

It is preferable that the elastomer 12 is cured so that some of the plurality of aramid fibers in the cloth layer 16 are able to move relative to the remaining plurality of aramid fibers 18. It is also preferable that the material 10 be configured to form a grip for a bat and/or racquet having a handle 24 and the proximal end 26. The grip 22 preferably encloses at least a portion of the handle 24 and the proximal end 26.

Another aspect of the present invention is directed to a method of making a grip 22 for an implement 20 having a handle 24 and a proximal end 26. The grip 22 is formed by a single layer material 10 adapted to regulate vibration. The method includes providing an uncured elastomer. A plurality of fibers 14 are positioned on and/or within the uncured elastomer 12. The uncured elastomer 12 is at least partially cured to form the single layer material embedding the plurality of fibers. The single layer material 10 has first and second major material surfaces. The single layer material 10 is positioned over at least a portion of the handle 24 and over the proximal end 26 of the handle 24. The first major material surface contacts the implement 20 and second major material surface of the single layer material 10 forms a surface for a user to grasp. This method can be used to form a grip 22 having any of the Shore A Durometers described above and can use any of the support structure 17 also described above.

In another aspect, the present invention is directed to a method of making a material 10 adapted to regulate vibration. The method includes providing a cloth 16 formed by a plurality of woven aramid fibers 14. The cloth has first and second major surfaces. A first elastomer layer 12A is placed on the first major surface of the cloth. A second elastomer layer 12B is placed on the second major surface 25 of the cloth 16. The first and second elastomer layers 12A, 12B penetrate the cloth 16 to form a single layer elastomer 12 having an embedded cloth 16 for support thereof.

In another aspect, the present invention is directed to a method of forming a material 10 including providing a cloth layer 16. Positioning an elastomer 12 substantially over the cloth layer 16. Applying pressure to the cloth layer 16 and the elastomer 12 to embed the cloth layer 16 on and/or in the elastomer 12 to form the material 10. When using this sort of pressure fit technique, those ordinary skill in the art will appreciate from this disclosure that the cloth layer 16 and the elastomer 12 can be placed in a mold prior to applying pressure without departing from the scope of the present invention.

The covering of the proximal end of an implement 20 by the grip 22 results in reduced vibration transmission and in improved counter balancing of the distal end of the implement 20 by moving the center of mass of the implement 20 closer to the hand of a user (i.e., closer to the proximal end 26). This facilitates the swinging of the implement 20 and can improve sports performance while reducing the fatigue associated with repetitive motion.

It is recognized by those skilled in the art, that changes may be made to the above-described embodiments of the invention without departing from the broad inventive concept thereof. For example, the material 10 may include additional layers (e.g., two or more additional layers) without departing from the scope of the present invention. It is understood, therefore, that this invention is not limited to the particular embodiments disclosed, but is intended to cover all modifications which are within the spirit and scope of the invention as defined by the appended claims and/or shown in the attached drawings.

We claim:

1. A material adapted to regulate vibration by distributing and partially dissipating vibration exerted thereon, the material comprising:
a first elastomer layer; and
a support structure penetrated by and embedded on and/or within the elastomer layer, the support structure being semi-rigid or rigid and supporting the elastomer layer, the support structure having a first plurality of particles therein.

2. The material of claim 1, wherein the support structure comprises a second elastomer layer including a plurality of fibers, the support structure having a greater rigidity than the elastomer layer.

3. The material of claim 2, wherein the plurality of fibers are woven.

4. The material of claim 3, wherein the plurality of fibers include aramid fibers.

5. The material of claim 1, wherein the first elastomer layer includes a second plurality of particles.

6. The material of claim 5, wherein at least one of the first and second plurality of particles includes gel particles.

7. The material of claim 5, wherein at least one of the first and second plurality of particles includes sand particles.

8. The material of claim 5, wherein at least one of the first and second plurality of particles includes glass beads.

9. The material of claim 2, wherein the second elastomer layer is formed of the same elastomer as the first elastomer layer, the plurality of fibers imparting a greater rigidity to the second elastomer layer relative to the rigidity of the first elastomer layer to make the support structure semi-rigid.

10. The material of claim 5, wherein the material is configured and adapted to form a grip for a tennis racquet having a handle and a proximal end, the material is adapted to enclose a portion of the handle and to enclose the proximal end of the tennis racquet.

11. The material of claim 5, wherein the material is configured and adapted to form a grip for an implement having a handle and a proximal end, the material is adapted to enclose a portion of the handle and to enclose the proximal end of the implement.

12. The material of claim 5, wherein the material is configured and adapted to form an insert for a shoe, the material being adapted to extend along an inner surface of the shoe from a location proximate to a heel of the shoe to a toe of the shoe.

13. A material adapted to regulate vibration by distributing and partially dissipating vibration exerted thereon, the material comprising:
a first elastomer layer; and
a support structure formed by a second elastomer layer, the support structure being located and configured to support the first elastomer layer.

14. The material of claim 13, wherein the support structure comprises a cloth layer.

15. The material of claim 14, wherein the support structure comprises a plurality of cloth layers.

16. The material of claim 14, wherein at least one of the plurality of cloth layers is formed of aramid fibers.

17. The material of claim 13, wherein the support structure includes a first plurality of particles therein.

18. The material of claim 16, wherein the first elastomer layer includes a second plurality of particles.

19. The material of claim 18, wherein at least one of the first and second plurality of particles includes gel particles.

20. The material of claim 18, wherein at least one of the first and second plurality of particles includes sand particles.

21. The material of claim 18, wherein at least one of the first and second plurality of particles includes glass beads.

22. The material of claim 18, wherein at least one of the first and second plurality of particles includes chopped fibers.

23. The material of claim 18, wherein at least one of the first and second plurality of particles includes metal particles.

24. The material of claim 19, wherein at least one of the first and second plurality of particles includes foam particles.

25. The material of claim 17, wherein the support structure includes a first plurality of fibers.

26. The material of claim 17, wherein the support structure comprises a cloth layer.

27. The material of claim 17, wherein the support structure comprises a plurality of cloth layers.

28. The material of claim 13, wherein the first elastomer layer includes a second plurality of particles.

29. The material of claim 28, wherein the first elastomer layer comprises a plurality of fibers.

30. A material adapted to regulate vibration by distributing and partially dissipating vibration exerted thereon, the material comprising:
a first elastomer layer; and
a support structure located and configured to support the elastomer layer, the support structure having a first plurality of gel particles therein.

31. The material of claim 30, wherein the first elastomer layer comprises a plurality of fibers.

32. The material of claim 30, wherein the support structure comprises a plurality of fibers.

33. The material of claim 30, wherein the support structure is formed, in part, by a polymer.

34. The material of claim 30, wherein the support structure is formed by a second elastomer layer.

35. The material of claim 30, wherein the first elastomer layer has a second plurality of gel particles therein.

36. The material of claim 5, wherein at least one of the first and second plurality of particles includes plastic particles.

37. The material of claim 5, wherein at least one of the first and second plurality of particles includes ceramic particles.

38. The material of claim 5, wherein at least one of the first and second plurality of particles includes aramid particles.

39. The material of claim 5, wherein at least one of the first and second plurality of particles includes glass particles.

40. The material of claim 3, wherein the plurality of fibers include metal fibers.

41. The material of claim 3, wherein the plurality of fibers include ceramic fibers.
